(19) United States
(12) Patent Application Publication
(10) Pub. No.: US 2011/0304504 A1
(43) Pub. Date: Dec. 15, 2011

(54) Adaptive Beamforming

(75) Inventors: Narayan Prasad, Wyncote, PA (US); Kishore Ramachandran, North Brunswick, NJ (US); Sampath Rangarajan, Bridgewater, NJ (US)

(73) Assignee: NEC LABORATORIES AMERICA, INC., Princeton, NJ (US)

(21) Appl. No.: 13/157,482

(22) Filed: Jun. 10, 2011

Related U.S. Application Data
(60) Provisional application No. 61/353,436, filed on Jun. 10, 2010.

(51) Int. Cl. H01Q 3/00

(52) U.S. Cl. 342/368

(57) ABSTRACT

A computer implemented method for generating transmit (TX) and receive (RX) antenna weight vectors (AWVs) for beamforming without utilizing explicit channel estimation.

### CROSS REFERENCE TO RELATED APPLICATION

This application claims the benefit of U.S. Provisional Patent Application Ser. No. 61/353,436 filed Jun. 10, 2010 the entire file wrapper of which is incorporated by reference as if set forth at length herein.

### FIELD OF DISCLOSURE

This disclosure relates to the field wireless communications and in particular to an adaptive beamforming method for 60 GHz wireless communication devices without explicit channel estimation.

### BACKGROUND OF DISCLOSURE

As may be appreciated by those skilled in the art, beamforming is an attractive technique to improve 60 GHz wireless communications due—in part—to its unique combination of high free space path loss and the potential for increased antenna directivity. As is known, beamforming (i.e. adaptive beamforming) involves dynamically changing beams or antenna patterns in signal space to maximize channel gain and minimize interference. Those skilled in the art will recognize that this is different, and more effective, than simple sector-level beam switching that basically points the beam in the right direction.

Adaptive beamforming may be implemented with an array of antenna elements, the signals sent to which are weighted in both magnitude and phase. The combination of these weighted signals when radiated by the antenna elements simultaneously form an antenna pattern that often takes complex shapes depending on the weights. The applied weights help reinforce energy is some directions, while reducing the energy in other (undesired) directions, thereby producing a high SNR (signal-to-noise-ratio) at the receiver compared to an omni-directional pattern.

In general, adaptive beamforming requires that these weights be computed based on an explicit channel estimation phase. In this estimation phase, a known signal (or set of training symbols) is sent from each transmit antenna element. Each receive antenna element estimates, and feeds back, the estimated channel gain seen from each transmit antenna based on the received known signal or received training symbols. The transmitter then computes the antenna weights based on channel feedback from the receiver.

With 60 GHz radios however, two issues limit the direct applicability of channel estimation in its current form. First, it may not always be possible to exchange a known set of training symbols between the TX and RX antenna element due to the increased signal attenuation caused by (a) the small size (small aperture area) of the antenna elements, and (b) high penetration loss due to link blockage. In many cases, a transmit and receive antenna element pair may not be able to communicate at all. Second, the typical use of a large number of antenna elements with these radios implies that even when all elements can communicate with each other, explicit channel estimation may not be practically feasible due to the time taken or the energy consumed.

Accordingly beamforming techniques that do not employ explicit channel estimation would represent a significant advance in the art.

### SUMMARY OF DISCLOSURE

An advance is made in the art according to an aspect of the present disclosure directed to adaptive beamforming without explicit channel estimation. According to an embodiment of the present disclosure, a training method is employed that restricts transmit and receive beamforming vectors to lie in a codebook comprising a number of vectors. All possible pairs are evaluated and the one resulting in the largest gain is chosen.

More particularly, a method of the instant disclosure is an iterative one that uses feedback about amplitude and phase of the effective scalar channel gain. The iterative method is advantageously able to quickly converge on the transmit and/or receive antenna weight vector. In a preferred operation, the method is robust to calibration errors as a transmit sector that is used as a starting point for transmit beamforming may advantageously be used as a starting point for receive beamforming. Such operation offers considerable advantage over prior art methods as the determination of a starting point for receive beamforming is frequently time consuming since—in prior art methods—it typically involves slowly sweeping across all sectors as part of an initial acquisition. Additionally, methods according to the present disclosure may work with antenna weight vectors which may be generated at runtime—in addition to those comprising the codebook.

In sharp contrast to the prior art, methods according to the present disclosure 1) generate a new set of beamforming vectors given a previous beamforming vector; and 2) update the previous beamforming vector based upon estimates of channel gains and delays corresponding to a generated new set of beamforming vectors.

Advantageously, methods according to the present disclosure exhibit reduced complexity in that explicit channel estimation is not employed, improved robustness to calibration errors, increased speed, and enhanced accuracy.

### BRIEF DESCRIPTION OF THE DRAWING

A more complete understanding of the disclosure may be realized by reference to the accompanying drawing in which:

FIG. 1 is a diagram depicting the prior art method of beamforming;

FIG. 2 is a pseudocode listing depicting the steps of a method according to the present disclosure; and

FIG. 3 is a pseudocode listing depicting the steps of a method according to the present disclosure.

### DESCRIPTION OF EMBODIMENTS

The following merely illustrates the principles of the various embodiments. It will thus be appreciated that those skilled in the art will be able to devise various arrangements which, although not explicitly described or shown herein, embody the principles of the embodiments and are included within their spirit and scope.

Furthermore, all examples and conditional language recited herein are principally intended expressly to be only for pedagogical purposes to aid the reader in understanding the principles of the embodiments and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative structures/circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions shown in the FIGs., including any functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the FIGs. are conceptual only. Their function may be carried out through the operation of program logic, through dedicated logic, through the interaction of program control and dedicated logic, or even manually, the particular technique being selectable by the implementer as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regard any means which can provide those functionalities as equivalent as those shown herein.

Unless otherwise explicitly specified herein, the drawings are not drawn to scale.

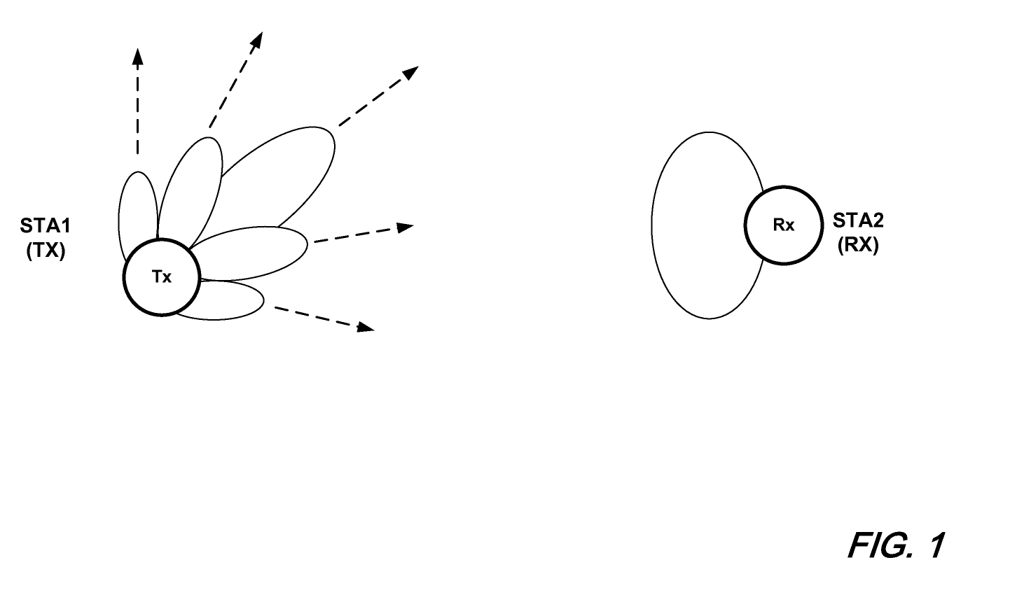

By way of some further background, it is noted that prior art beamforming techniques (See, FIG. 1) include an initial signal acquisition stage (Stage 1) between two stations (STA1, STA2) communicating via 60 GHz radios wherein each one of the two stations tries out a set of transmit beams (or sectors) covering the entire 360 degree azimuthal plane in an attempt to determine the best sector for communication. Conventionally, the best transmit sector chosen by the transmitter or receiver is determined from an implementation-dependent parameter such as signal to noise ratio (SNR).

During this stage 1, the receiving station uses a quasi-omni receive antenna pattern. As shown in FIG. 1, the best TX sector ID is determined and conveyed to the TX, e.g., ID_{TX} #1.

In addition, the prior art employs additional stages which may determine a best receive sector or to determine a best transmit and receive sectors based on a simultaneous trial of transmit and receive sectors. Inasmuch as these additional stages are not generally illuminating with respect to a method according to the present disclosure and advantageously may interoperate with such methods, they are not described further here.

We now consider beamforming for STA1. In stage 1, a transmit antenna weight vector (AWV) is chosen by sweeping through a pre-determined number of AWVs from a codebook (or transmit sectors). For example—and with continued reference to FIG. 1, on each transmit AWV, STA1 sends a packet to STA2. Upon receiving the packet, STA2 records information about the transmit AWV ID—which may be included in each packet—and metrics related to packet reception, e.g., signal strength. STA2 uses these metrics to determine the best transmit AWV, which information is provided back to STA1 after all AWVs have been evaluated.

With respect to receive AWVs, STA2 can either employ (a) a quasi-omni pattern, (b) the best receive AWV selected from a RX sector sweep stage or (c) the best transmit AWV from the TX sector sweep stage in the reverse direction—i.e., STA2 is transmitting and STA1 is receiving.

With this prior art description of stage 1 in place, we now turn to a discussion of stage 2—the adaptive beamforming stage—wherein a method according to the present disclosure is practiced.

Using the initial (coarse) determination of transmit and receive AWVs or beamforming vectors as inputs, a method according to the present disclosure progressively refines transmit and receive beamforming vectors in an alternating manner. More particularly—while holding the receive beamforming vector fixed—the transmit beamforming vector is updated in a transmit beamforming training stage. Then—holding the transmit beamforming vector fixed—the receive beamforming vector is updated in a receive beamforming training stage. This alternating process continues until convergence or until a maximum number of iterations is reached.

In the transmit beamforming training stage, given a previous transmit beamforming vector, the transmitter first generates a new set of beamforming vectors. It then sequentially transmits using vectors from this set. To receive the training packets sent on each of these vectors, the receiver uses the receive beamforming vector with the maximum receive gain (as established up to this point). Note that this could be a (quasi-) omni beam if the receive beamforming has not yet been executed. The receiver estimates one or more channel gains and delays corresponding to each transmit beamforming vector and feeds back these estimated gains and associated delays to the transmitter. The transmitter then updates its beamforming vector based on the received feedback.

Similarly, in the receive beamforming training stage, given the previous receive beamforming vector, the receiver first generates a new set of beamforming vectors. It then sequentially uses vectors from this set. The transmitter repeats sending training packets for each of these receive beamforming vectors using the transmit beamforming vector with the maximum transmit gain (as established so far). The receiver estimates one or more channel gains and delays corresponding to each beamforming vector it attempts. It then updates its beamforming vector based on these estimates.

At this point those skilled in the art will appreciate that the method of the present disclosure 1) generates a new set of beamforming vectors given a previous beamforming vector; and 2) updates the previous beamforming vector based upon estimates of channel gains and delays corresponding to a generated new set of beamforming vectors. Such operations are conveniently performed by digital computer.

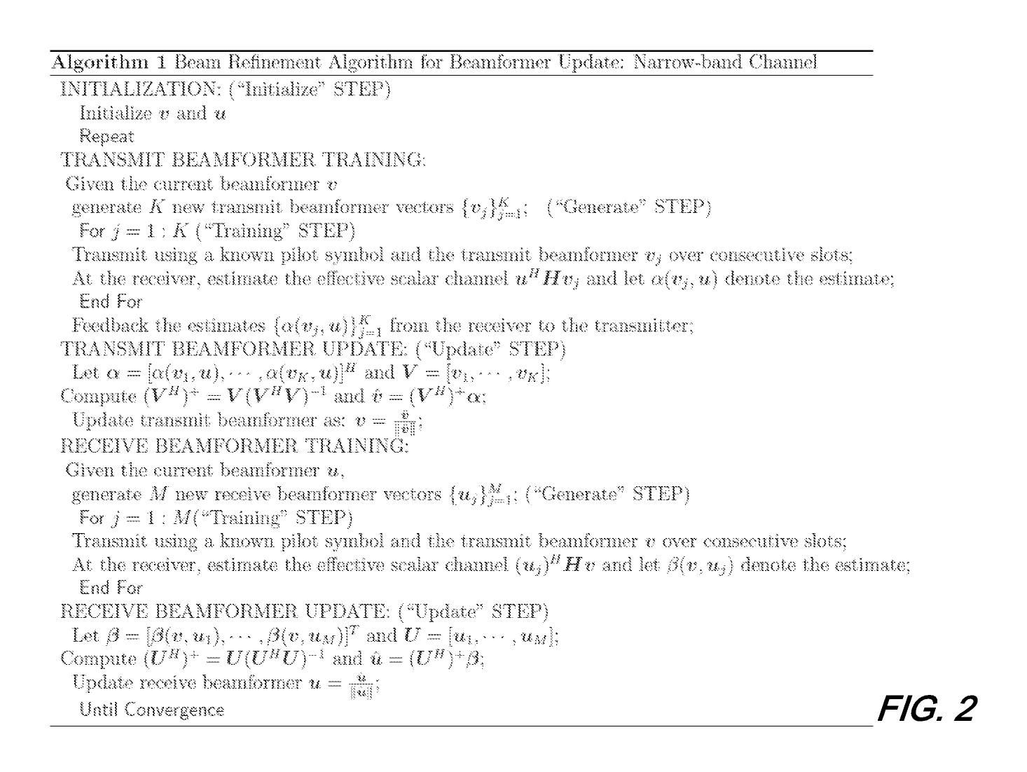

Turning now to FIG. 2, there is shown a pseudocode listing for a beam refinement and update method for a narrow-band channel according to an aspect of the present disclosure. More particularly, the method depicted in that pseudocode listing comprises a number of operations or steps, namely an INITIALIZATION Step, a TX BEAMFORMER GENERATE Step, a TX BEAMFORMER TRAINING step, a TX BEAMFORMER UPDATE Step, an RX BEAMFORMER GENERATE Step, an RX BEAMFORMER TRAINING Step, and an RX BEAMFORMER UPDATE Step. Collectively, the TX BEAMFORMER GENERATE, TX BEAMFORMER TRAINING, and TX BEAMFORMER UPDATE steps are known as the TRANSMIT BEAMFORMER TRAINING. Similarly, the RX BEAMFORMER GENERATE, RX BEAMFORMER TRAINING and RX BEAMFORMER UPDATE steps are collectively known as RECEIVE BEAMFORMER TRAINING.

As may be observed from the pseudocode listing of FIG. 2, initial choices of beamforming vectors are chosen. Holding the receive beamformer fixed, the transmit beamformer is updated. Then, holding the transmit beamformer fixed, the receive beamformer is updated. The process continues until convergence or a maximum number of iterations is reached.

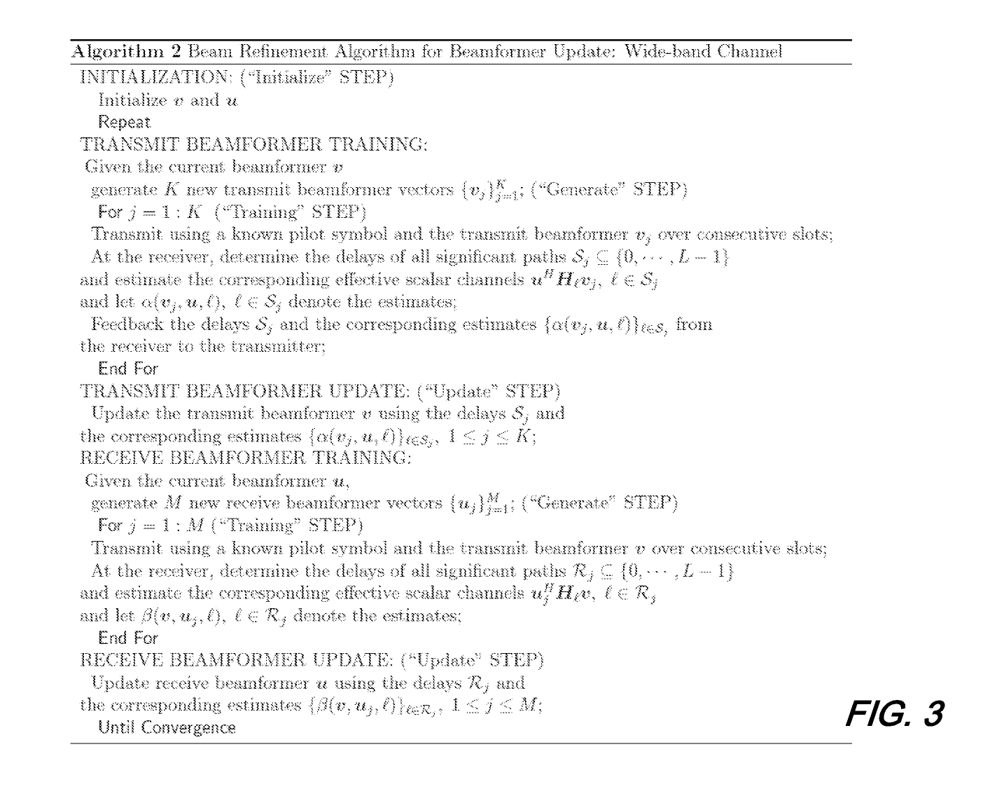

Turning now to FIG. 3, there is shown a pseudocode listing for a beam refinement and update method for a wide-band MIMO channel according to an aspect of the present disclosure. More particularly, the method depicted in that pseudocode listing comprises a number of operations or steps, namely an INITIALIZATION Step, a TX BEAMFORMER GENERATE Step, a TX BEAMFORMER TRAINING step, a TX BEAMFORMER UPDATE Step, an RX BEAMFORMER GENERATE Step, an RX BEAMFORMER TRAINING Step, and an RX BEAMFORMER UPDATE Step. Collectively, the TX BEAMFORMER GENERATE, TX BEAMFORMER TRAINING, and TX BEAMFORMER UPDATE steps are known as the TRANSMIT BEAMFORMER TRAINING. Similarly, the RX BEAMFORMER GENERATE, RX BEAMFORMER TRAINING and RX BEAMFORMER UPDATE steps are collectively known as RECEIVE BEAMFORMER TRAINING.

At this point, while we have discussed and described the invention using some specific examples, those skilled in the art will recognize that our teachings are not so limited. Accordingly, the invention should be only limited by the scope of the claims attached hereto.

1. A method of generating transmit (TX) and receive (RX) antenna weight vectors (AWVs) for beamforming without explicit channel estimation, said method comprising the steps of:
using an initial pair of TX and RX AWVs, successively refining the TX and RX AWVs in an alternating manner until one of a pre-determined convergence or number of iterations is reached.

2. The method of claim 1 wherein said successive refinement comprises the steps of:
holding the RX AWV fixed; and
updating the TX AWV.

3. The method of claim 1 wherein said successive refinement step comprises the steps of:
holding the TX AWV fixed; and
updating the RX AWV.

4. The method of claim 3 further comprising the steps of:
training the receive AWV by:
generating a number of receive beamformer vectors
transmitting using the fixed transmit AWV a known pilot symbol over consecutive slots;
for each of the generated receive beamformer vector, determining delays of all significant paths and estimating corresponding effective scalar channels; and
updating the receive AWV using the corresponding delays and estimates.

5. The method of claim 2 further comprising the steps of:
training the transmit AWV by
generating a number of transmit beamformer vectors;
transmitting using each of the generated transmit beamformer vector a known pilot symbol over consecutive slots;
determining delays of all significant paths and estimating corresponding effective scalar channels;
providing the determined delays and estimates to the transmitter; and
updating the transmit AWV using the delays and estimates.

6. The method of claim 1 further comprising the steps of:
determining the initial pair of TX and RX AWVs using one or more sector sweeps; and
determining whether the TX or RX AWV is to be successively refined first.

7. The method of claim 1 further comprising the steps of:
generating at least one of a set of mutually orthogonal TX beamformer vectors that includes a previous TX AWV and a set of mutually orthogonal RX beamformer vectors that includes a previous RX AWV.

8. The method of claim 7 wherein said generating is performed through the effect of a Householder transformation.

9. The method of claim 1 further comprising the steps of:
generating at least one of a set of mutually orthogonal, constant-magnitude TX beamformer vectors that includes a previous TX AWV and a set of mutually orthogonal, constant-magnitude RX beamformer vectors that includes a previous RX AWV, wherein said generating is performed through the effect of a Discrete Fourier Transform transformation.

10. The method of claim 1 further comprising the steps of:
generating at least one of a set of mutually near-orthogonal TX beamformer vectors that lies in a finite codebook and includes a previous TX AWV and a set of mutually near-orthogonal RX beamformer vectors that lies in a finite codebook and includes a previous RX AWV.

11. The method of claim 1 wherein said TX and RX AWVs are updated based on estimates of channel gains and delays such that at least one of the updated TX and RX AWVs satisfies a norm constraint.

12. The method of claim 1 wherein said TX and RX AWVs are updated based on estimates of channel gains and delays such that at least one of the updated TX and RX AWVs satisfies a constant-magnitude constraint.

13. The method of claim 1 wherein said TX and RX AWVs are updated based on estimates of channel gains and delays such that at least one of the updated TX and RX AWVs belongs to a finite codebook.

14. The method of claim 1 wherein said TX and RX AWVs are updated based on estimates of channel gains and delays such that at least one of the updated TX and RX AWVs satisfies a per element magnitude constraint.

15. The method of claim 11 wherein said update is determined by introducing auxiliary variables and optimizing said auxiliary variables in an alternating manner until one of a pre-determined convergence or number of iterations is reached.

16. The method of claim 1 further comprising the steps of:
determining the initial pair of TX and RX AWVs using one or more sector sweeps; and
determining whether the TX or RX AWV is to be successively refined first.
